(19) United States
(12) Patent Application Publication
(10) Pub. No.: US 2020/0131812 A1
(43) Pub. Date: Apr. 30, 2020

(54) DOOR KEY CYLINDER IN CLADDING

(71) Applicant: Byton North America Corporation, Santa Clara, CA (US)

(72) Inventors: Shawn Slovesko, Santa Clara, CA (US); Xiaocheng Zhang, San Jose, CA (US)

(21) Appl. No.: 16/172,586

(22) Filed: Oct. 26, 2018

(51) Int. Cl. E05B 81/90; E05B 79/08; E05B 79/20; E05B 85/06

(52) U.S. Cl. CPC E05B 81/90; E05B 85/06; E05B 79/20; E05B 79/08

(57) ABSTRACT

Embodiments are disclosed of an apparatus including a vehicle door having an interior side, an exterior side, and a door cavity between the interior side and the exterior side. An electrically-operated door latch-and-lock mechanism positioned in the door cavity, and the latch-and-lock mechanism includes a mechanical override that allows the latch-and-lock mechanism to be locked, unlocked, and unlatched in the absence of electrical power. A secure activation mechanism positioned remotely from the latch-and-lock mechanism on the exterior side of the vehicle door, and a mechanical is link positioned in the door cavity. The mechanical link couples the secure activation mechanism to the mechanical override so that the secure activation mechanism can be used to activate the mechanical override to lock, unlock or unlatch the latch-and-lock mechanism.

### TECHNICAL FIELD

The disclosed embodiments relate generally to vehicle doors and in particular, but not exclusively, to a secure locking, unlocking, and unlatching mechanism on the door of an electric vehicle.

### BACKGROUND

Gas-powered vehicles are slowly being replaced by vehicles that electrically powered, either partially or wholly. Until now the move to electrically-powered vehicles has been limited to passenger vehicles, but manufacturers like Tesla already have commercial vehicles such as trucks in the works. Some governments have mandated a complete transition to electrically powered vehicles by a certain year.

In electric vehicles it can be desirable to reduce the structural weight to account for the weight of the batteries and also to improve the vehicle's aerodynamics to improve its range, all while maintaining an aesthetic appearance that will be pleasing to customers. To improve aerodynamics, for instance, it can be desirable to have no excrescences such as door handles, or to make such excrescences retractable. And to reduce structural weight it can be desirable to reduce component sizes, for instance by reducing door thicknesses. But these requirements can counter each other: retractable excrescences require somewhere to retract to, but thinner doors provide less space for retraction. Other components that don't retract might also need more door thickness than is available, making their design and placement in the vehicle more difficult.

### SUMMARY

Embodiments are disclosed of an apparatus including a vehicle door having an interior side, an exterior side, and a door cavity between the interior side and the exterior side. An electrically-operated door latch-and-lock mechanism positioned in the door cavity, and the latch-and-lock mechanism includes a mechanical override that allows the latch-and-lock mechanism to be locked, unlocked, and unlatched in the absence of electrical power. A secure activation mechanism positioned remotely from the latch-and-lock mechanism on the exterior side of the vehicle door, and a mechanical link positioned in the door cavity. The mechanical link couples the secure activation mechanism to the mechanical override so that the secure activation mechanism can be used to activate the mechanical override to lock, unlock or unlatch the latch-and-lock mechanism.

Embodiments are disclosed of a vehicle including a frame with at least one door opening with hinges on one side of the door opening and a latch post on another side of the door opening. A vehicle door is mounted to the hinges so that it can rotate about the hinges between an open position and a closed position. The vehicle door has an interior side, an exterior side, and a door cavity between the interior side and the exterior side. An electrically-operated door latch-and-lock mechanism is positioned in the door cavity so that it can engage the latch post when the vehicle door is in its closed position, and the latch-and-lock mechanism includes a mechanical override that allows the latch-and-lock mechanism to be locked, unlocked, and unlatched in the absence of electrical power. A secure activation mechanism is positioned remotely from the latch-and-lock mechanism on the exterior side of the vehicle door and a mechanical link is positioned in the door cavity. The mechanical link couples the secure activation mechanism to the mechanical override so that the secure activation mechanism can be used to activate the mechanical override to lock, unlock or unlatch the latch-and-lock mechanism.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of an embodiment of a vehicle body.

FIG. 2 is a perspective view of an embodiment of a vehicle door that can be used with the vehicle body of FIG. 1.

FIG. 3 is a side view of a vehicle door illustrating an embodiment of the positioning in the door of an apparatus for locking, unlocking, and unlatching the vehicle door.

FIGS. 4A-4C are perspective views of an embodiment of a secure activation mechanism for locking, unlocking, and unlatching a vehicle door.

FIGS. 5A-5B are perspective views of an embodiment of a secure activation mechanism for locking, unlocking, and unlatching a vehicle door. FIG. 5A shows the secure activation mechanism in its closed position, FIG. 5B in its open position.

FIGS. 6A-6B are perspective views of another embodiment of a secure activation mechanism for locking, unlocking, and unlatching a vehicle door. FIG. 6A shows the secure activation mechanism in isolation and FIG. 6B shows it in its installed position.

FIGS. 7A-7B are drawings of another embodiment of a secure activation mechanism for locking, unlocking, and unlatching a vehicle door. FIG. 7A is a plan view, FIG. 7B a sectional view.

FIG. 8 is a plan view of the embodiment of a secure activation mechanism of FIG. 7, installed in cladding and having its door closed.

### DETAILED DESCRIPTION

Many systems in a vehicle are electrically powered. In fully electric vehicles all power for vehicle systems comes from the vehicle's battery, meaning that if the battery fails, is fully depleted, or otherwise cannot deliver power, many systems won't operate. In particular, in a vehicle with electrically-powered door locks and latches, if the battery fails while the vehicle user is outside the vehicle, the user might be unable to access the vehicle. It is therefore useful to have electrically-powered door locks and latches that have a mechanical override, and to have a mechanical override can be accessed from the exterior of the vehicle, so that the vehicle can be unlocked, unlatched, or locked if the battery fails. An apparatus is disclosed below that includes an electrically-operated lock-and-latch mechanism with a mechanical override that allows the lock-and-latch mechanism to be operated without electrical power. A secure activation mechanism is positioned on the exterior of a vehicle door and is coupled to the mechanical override, so that the vehicle can be locked, unlocked, and unlatched if no electrical power is available for the lock-and-latch mechanism.

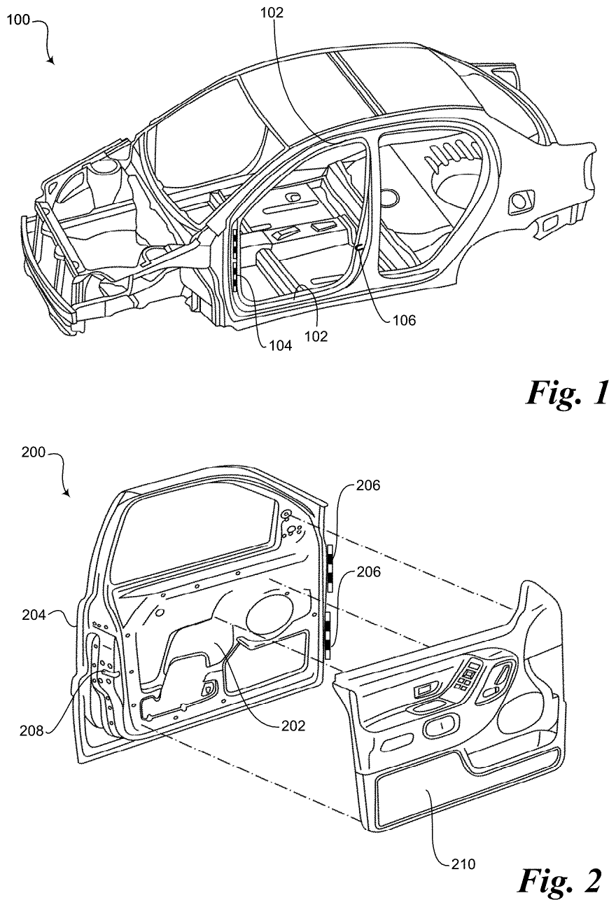

FIG. 1 illustrates an embodiment of a vehicle body 100. Vehicle body 100 includes one or more door openings 102 designed to accommodate the vehicle's doors. The illustrated embodiment of vehicle body 100 has 4 doors, but other embodiments can include more or less doors; other embodiments, for instance, can have 2 doors, 3 doors, 5 doors, or some other number. Moreover, in the illustrated embodiment vehicle body 100 is the body of a passenger sedan, but in other embodiments vehicle body 100 can be the body of a different type of vehicle such as a sport-utility vehicle (SUV), minivan, pickup truck, or commercial vehicle such as a truck.

Each door opening 102 includes one or more hinges 104 on one side of the door. Hinges 104 are designed to engage with corresponding hinges, or with some other mechanism, on the doors that will be positioned in the openings. Each door opening 102 also includes a latch post 106 on another side of the door. When the door is closed, the lock-and-latch mechanism in the door will engage with latch post 106 to keep the door closed, locked, or both. In the illustrated embodiment latch post 106 is on the side of the door opening 102 opposite the side where hinges 104 are positioned, but in other embodiments latch post 106 can be on a different side of door opening 102 than illustrated.

FIG. 2 illustrates an embodiment of a vehicle door 200 that can be used with vehicle body 100. Vehicle door 200 includes a main body with an interior side 202 and an exterior side 204. Interior side 202 and exterior side 204 can be made of stamped or otherwise shaped sheet metal in one embodiment. A pair of hinges 206, or some other mechanism to engage hinges 104, is positioned on one edge of the door.

Interior side 202 and exterior side 204 are assembled in such a way as to form an internal door cavity between them. The door cavity between interior side 202 and exterior side 204 accommodates various door hardware and systems, including a latch-and-lock mechanism 208. Latch-and-lock mechanism is positioned in the door cavity along the edge of the door that will allow it to engage with latch post 106. In the illustrated embodiment latch-and-lock mechanism 208 is positioned in the edge of door 200 opposite the edge where hinges 206 are positioned, but in other embodiments latch-and-lock mechanism 208 can be positioned in a different door edge than shown. An interior panel 210 is attached to interior side 202 for cosmetic reasons and also to provide controls to the user for various systems in or on the door 200, such as windows, locks, and mirrors.

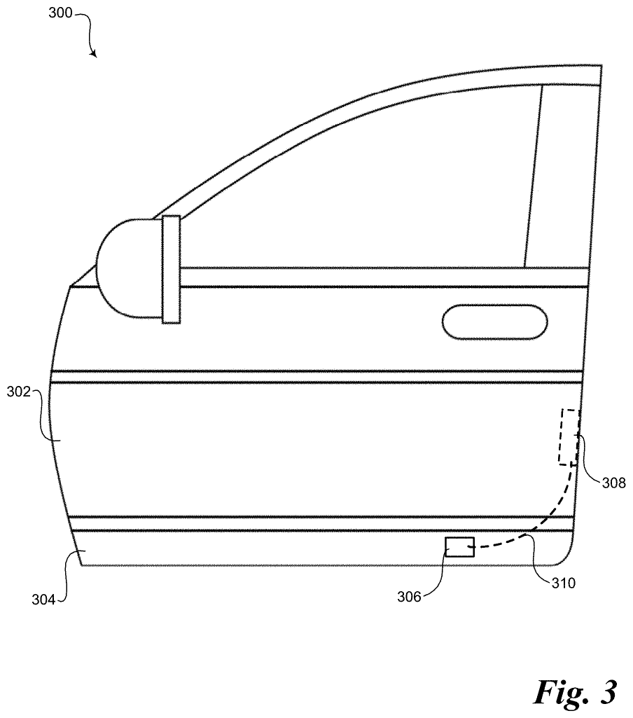

FIG. 3 schematically illustrates an embodiment of a vehicle door 300 that can be used as an embodiment of vehicle door 200. Vehicle door 300 includes an exterior side 302, at the bottom of which is attached a layer of cladding 304. Cladding 304 is attached to the sheet metal that makes up exterior side 302 for cosmetic reasons and to protect the lower of door 300 from impacts. In one embodiment, cladding 304 can be a plastic layer attached to exterior side 302, but in other embodiments cladding 304 can be made of other materials such as metals. In still other embodiments, cladding 304 can be a composite of multiple materials or multiple layers of materials. For instance, in one embodiment cladding 304 can be chrome-covered plastic or plastic-covered sheet metal.

Positioned within the door cavity—and thus shown with dashed lines in the drawing—is a latch-and-lock mechanism 308 positioned at the edge of door 300 that corresponds to the side of the door opening where latch post 106 is located. In an electric vehicle, latch-and-lock mechanism 308 is electrically operated, but nonetheless includes a mechanical override that allows the latch-and-lock mechanism to be mechanically locked, unlocked, and unlatched if a battery failure prevents electrical power from being delivered to the latch-and-lock mechanism. Embodiments of latch-and-lock mechanism 308 are commercially available, for instance from Kiekert AG of Heilienghaus, Germany.

A secure activation mechanism 306 is positioned on the exterior side of door 300, where it can be accessed by a user from the outside of the vehicle. Secure activation mechanism 306 is positioned remotely from latch-and-lock mechanism 308, meaning that it is positioned at a location on door 300 different from where the latch-and-lock is positioned. If the latch-and-lock mechanism and the secure activation mechanism were substantially co-located, for instance with the latch-and-lock mechanism inside the door cavity of door 300 and the secure activation mechanism immediately on the other side of exterior side 302 from the latch-and-lock mechanism, the secure activation mechanism would not be positioned remotely from the latch-and-lock mechanism. In the illustrated embodiment, secure activation mechanism 306 is positioned in cladding 304 and in the sheet-metal of exterior side 302 of door 300, but in other embodiments could be positioned elsewhere on the door, for instance under other door trim pieces or at another location on the door where its appearance can be minimized so as to maintain the aesthetic appearance of the vehicle. “Secure” in this context means that activation mechanism 306 can only be activated by a user with the right credentials; in one embodiment the required credential can be a physical key. A mechanical link 310 also shown with dashed lines to indicate that it is within the door cavity couples secure activation mechanism 306 to the mechanical override of latch-and-lock mechanism 308. In one embodiment mechanical link 310 can be a cable, but in other embodiments it can be some other type of mechanical link; in one embodiment, for instance, mechanical link 310 can be one or more rigid members such as bars that can be pushed or pulled, but in other embodiments mechanical link 310 can be a flexible link that can be pushed and pulled, such as a sheathed cable.

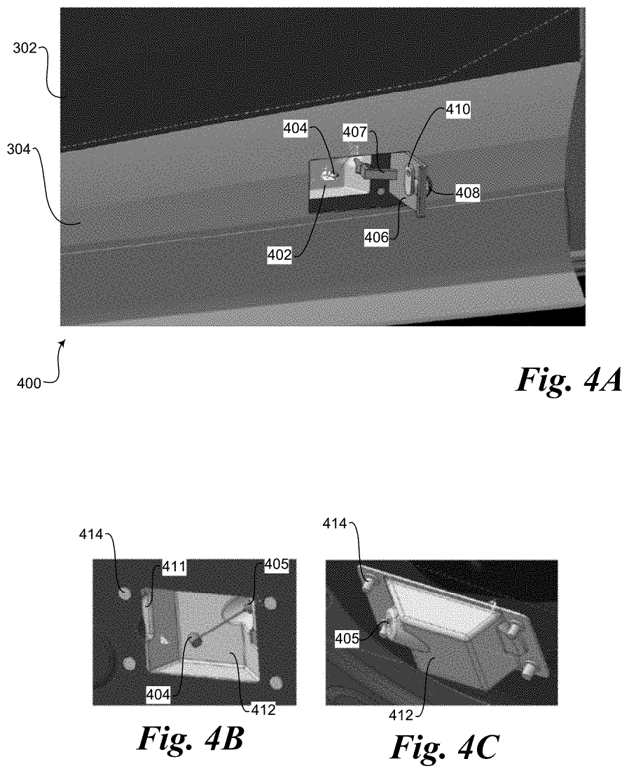

FIGS. 4A-4C together illustrate an embodiment of a secure activation mechanism 400. Secure activation mechanism 400 includes a housing 412 positioned inside the door cavity and attached to the inside of exterior side of the door. In one embodiment housing 412 can be attached to the interior of exterior side 302 with weld studs 414. When installed on the door, weld studs 414 can be on the interior exterior side 302 or can extend through the exterior side 302, cladding 304, or both. Housing 412, when installed on the door, forms a cavity 402 that can be accessed from outside the vehicle via door 406. Door 406 is coupled to housing 412 via a hinge 407, and on the side of housing 412 opposite hinge 407 is a recess 411 that engages rotating tab 410 when the tab is rotated to its locked position. Door 406 can be locked and unlocked via a lock cylinder 408 that is coupled to rotating tab 410. In other embodiments, door 406 need not be coupled to housing 412 by a hinge, but can instead be removed upon unlocking it.

A mechanical link 404 that can be used to activate the mechanical override on the latch-and-lock mechanism 308 projects into the interior of cavity 402 where it can be grasped by the user and pulled or pushed to lock, unlock, or unlatch the vehicle door. Mechanical link 404 projects into the interior of cavity 402 through feed 405 in housing 412. In the illustrated embodiment mechanical link 404 is a cable, but in other embodiments it can be some other type of mechanical link.

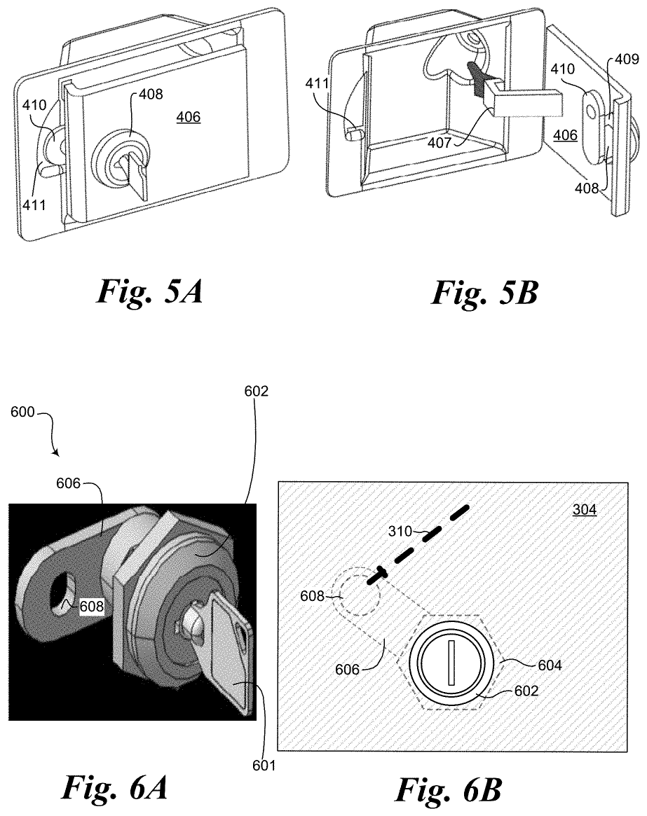

FIGS. 5A-5B together illustrate the operation of secure activation mechanism 400. FIG. 5A illustrates its closed position, FIG. 5B its open position. In FIG. 5A, door 406 is in its closed and locked position, with rotating tab 410 engaged in recess 411 so that door 406 cannot be opened. As shown in FIG. 5B, to operate secure activation mechanism 400, a key is first inserted into lock cylinder 408 and the key is then turned to rotate lock cylinder 408. Lock cylinder 408 is secured in place by a nut 409 on the inner side of door 406, thus preventing an unauthorized user from gaining access simply by taking apart the mechanism. Tab 410 is coupled to lock cylinder 408, so that when lock cylinder 408 is rotated tab 410 also rotates and is displaced from its locked position, where it engages with recess 411, to its open position. Once door 406 is unlocked it can be opened by turning it about hinge 407, thus giving a user access to cavity 402 and to the mechanical link 404 that extends into that compartment (not shown in this figure, but see FIGS. 4A-4C), such that the mechanical link can be pulled, pushed, or otherwise activated by the user.

FIGS. 6A-6B illustrate another embodiment of a secure activation mechanism 600. FIG. 6A shows the mechanism in its uninstalled position, while FIG. 6B shows the mechanism installed in exterior side 302 and cladding 304. Instead of creating a compartment within the door cavity, a lock cylinder 602 can be fixed directly to exterior side 302 and cladding 304. Lock cylinder 602 is installed such that the cladding 304 and/or the sheet-metal exterior 302 of the door is sandwiched between nut 604 and the exterior part of lock cylinder 602 where key 601 is inserted. A tab 606 extends substantially normal to an axis of the lock cylinder and has a hole 608 in it. Hole 608 is used to receive and secure mechanical link 310. Tab 606, hole 608, and mechanical link 310 are shown in dashed lines in FIG. 6B to indicate that they are within the door cavity, while lock cylinder 602 is fixed outside the cavity on the exterior side of the vehicle door while nut 604 is positioned inside the exterior side 302 of the door where it cannot be accessed, thus preventing an unauthorized user from gaining access simply by disassembling the mechanism.

In operation, the user inserts key 601 into lock cylinder 602 and turns it, thus displacing tab 606. Because mechanical link 310 is coupled to tab 606 via hole 608, displacement of tab 606 causes displacement of mechanical link 310, for instance by pulling or pushing on it. When pulled or pushed, mechanical link 310 in turn activates the mechanical override in latch-and-lock mechanism 308, thus unlocking, locking, unlocking, or unlatching the door.

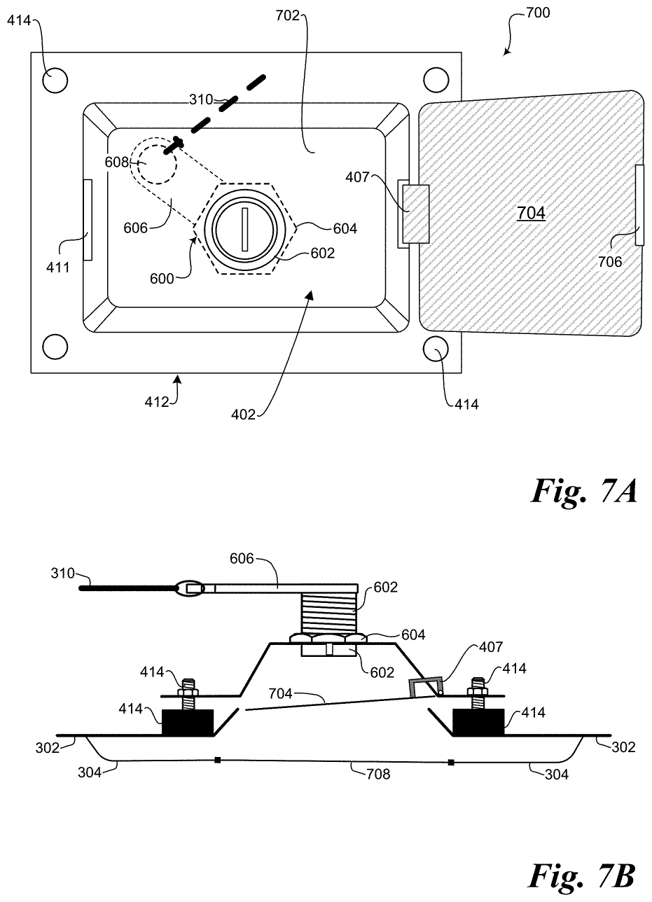

FIGS. 7A-7B together illustrate another embodiment of a secure activation mechanism 700 that combines elements of secure activation mechanisms 400 and 600. FIG. 7A is a plan view, FIG. 7B a sectional view. Secure activation mechanism 700 includes a housing 412 from which feed 405 has been removed. Housing 412 can be positioned in the interior cavity of door 300 and attached to the interior surface of exterior side 302 of the door. In the illustrated embodiment one or more weld studs 414 are welded to the interior surface of exterior side 302 around the perimeter of an opening in exterior side 302. Housing 412 can then be secured to exterior side 302 by placing it on weld studs 414 and securing it in place with nuts. Other embodiments can use other ways of securing housing 412 to exterior side 302 while reducing or minimizing the visual impact on the vehicle exterior.

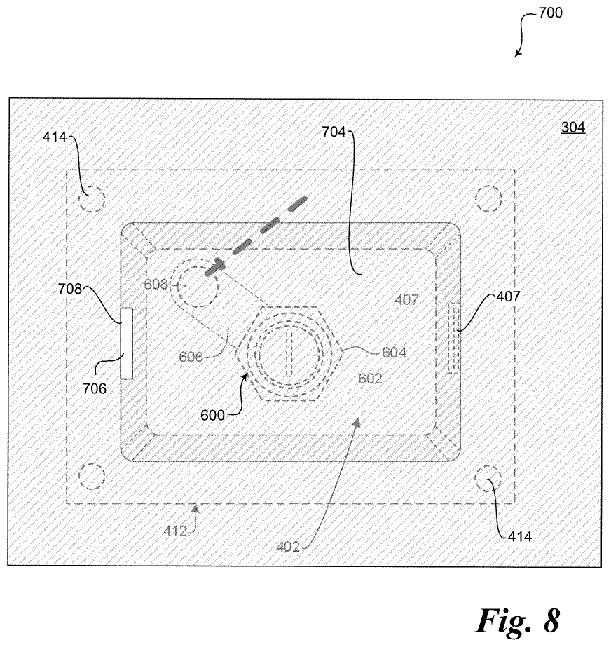

The illustrated embodiment of housing 412 includes an door 704 without a lock attached to housing 412 via hinge 407, but in other embodiments door 704 can be detachable instead of hinged. Door 704 includes a tab 706, or another structure such as a clip or lip, that can engage recess 411 to keep the door closed (see FIG. 8). In the illustrated embodiment door 704 is rectangular, but other embodiments of door 704 can be round, square, rectangular, or some other shape. Generally the shape of door 704 will match the shape of cavity 402, so that cavity 402 can correspondingly be round, square, rectangular, or some other shape. A second door 708 can be positioned in cladding 304. To preserve the aesthetics of the vehicle exterior, door 708 can be designed to be removable yet have a low visibility on the vehicle exterior that is, to have a minimal impact on the vehicle's aesthetics. In one embodiment second door 708 can be a fully removable door held in place by tabs and having a small slot or opening into which a tool, coin, or other object can be inserted to remove the door. In still other embodiments doors 704 and 708 can be combined into a single door, for instance by making door 704 thicker so that its outside surface is flush with cladding 304. Housing 412 forms a cavity 402 with a rear wall 702, and secure activation mechanism 600 mounted on rear wall 702 instead of the exterior side of the door. In such an embodiment door 704 would be on the exterior of the vehicle, which could be less conspicuous and more visually appealing. But the mechanism would still be secure; the user could access cavity 402 without a key, but would still need a key to activate the lock cylinder 602 in the compartment.

FIG. 8 illustrates secure activation mechanism 700 installed in cladding 304 with door 704 closed. Secure activation mechanism 600, housing 412, and weld studs 414 are shown in dashed lines to indicate that they are behind door 704 and thus not visible when the door is closed. In the illustrated embodiment door 704 can be made of the same material as cladding 304 and can be made to have a smooth profile and not stand out; in other words, door 704 masks cavity 402 when door 704 is closed, and blends in with cladding 304 so that it is inconspicuous and visually appealing. But in other embodiments door 302 need not have cladding 304; in such embodiments, door 704 can be simply part of exterior side 302 of the door. When door 704 is closed, tab, clip, or lip 706 engages recess 411 to keep the door closed. A small opening or cutout 708 in door 704 allow a person's finger, fingernail, a coin, a screwdriver, or some other implement to be used inserted to deflect tab 706 and open door 704.

The above description of embodiments, including what is described in the abstract, is not intended to be exhaustive or to limit the invention to the described forms. Specific embodiments of, and examples for, the invention are described herein for illustrative purposes, but various equivalent modifications are possible within the scope of the invention in light of the above detailed description, as those skilled in the relevant art will recognize.

What is claimed is:

1. An apparatus comprising:
a vehicle door having an interior side, an exterior side, and a door cavity between the interior side and the exterior side;
an electrically-operated door latch-and-lock mechanism positioned in the door cavity, the latch-and-lock mechanism including a mechanical override that allows the latch-and-lock mechanism to be locked, unlocked, and unlatched in the absence of electrical power;
a secure activation mechanism positioned remotely from the latch-and-lock mechanism on the exterior side of the vehicle door; and
a mechanical link positioned in the door cavity, the mechanical link coupling the secure activation mechanism to the mechanical override so that the secure activation mechanism can be used to activate the mechanical override to lock, unlock or unlatch the latch-and-lock mechanism.

2. The apparatus of claim 1 wherein the secure activation mechanism comprises a key-operated lock cylinder coupled to the mechanical link.

3. The apparatus of claim 2 wherein the exterior side of the vehicle door includes a layer of cladding and wherein the key-operated lock cylinder is positioned in the cladding.

4. The apparatus of claim 1 wherein the secure activation mechanism comprises:
a compartment in the door cavity, wherein a part of the mechanical link extends into an interior of the compartment so that it can be grabbed by a user's hand; and
a locked access door on the exterior side of the vehicle door, the access door leading to the interior of the compartment.

5. The apparatus of claim 4 wherein the exterior side of the vehicle door includes a layer of cladding and wherein the locked access door is positioned in the cladding.

6. The apparatus of claim 1 wherein the secure activation mechanism comprises:
a compartment in the door cavity;
an access door on an exterior side of the vehicle door, the access door leading to an interior of the compartment; and
a key-operated lock cylinder positioned in the interior of the compartment and coupled to the mechanical link.

7. The apparatus of claim 6 wherein the exterior side of the vehicle door includes a layer of cladding and wherein the access door is positioned in the cladding.

8. The apparatus of claim 1 wherein the mechanical link is a cable.

9. A vehicle comprising:
a vehicle including a frame with at least one door opening with hinges on one side of the door opening and a latch post on another side of the door opening;
a vehicle door mounted to the hinges so that it can rotate about the hinges between an open position and a closed position, the vehicle door having an interior side, an exterior side, and a door cavity between the interior side and the exterior side;
an electrically-operated door latch-and-lock mechanism positioned in the door cavity so that it can engage the latch post when the vehicle door is in its closed position, the latch-and-lock mechanism including a mechanical override that allows the latch-and-lock mechanism to be locked, unlocked, and unlatched in the absence of electrical power;
a secure activation mechanism positioned remotely from the latch-and-lock mechanism on the exterior side of the vehicle door; and
a mechanical link positioned in the door cavity, the mechanical link coupling the secure activation mechanism to the mechanical override so that the secure activation mechanism can be used to activate the mechanical override to lock, unlock or unlatch the latch-and-lock mechanism.

10. The vehicle of claim 9 wherein the secure activation mechanism comprises a key-operated lock cylinder coupled to the mechanical link.

11. The vehicle of claim 10 wherein the exterior side of the vehicle door includes a layer of cladding and wherein the key-operated lock cylinder is positioned in the cladding.

12. The vehicle of claim 9 wherein the secure activation mechanism comprises:
a compartment in the door cavity, wherein a part of the mechanical link extends into an interior of the compartment so that it can be grabbed by a user's hand; and
a locked access door on the exterior side of the vehicle door, the access door leading to the interior of the compartment.

13. The vehicle of claim 12 wherein the exterior side of the vehicle door includes a layer of cladding and wherein the locked access door is positioned in the cladding.

14. The vehicle of claim 9 wherein the secure activation mechanism comprises:
a compartment in the door cavity;
an access door on an exterior side of the vehicle door, the access door leading to an interior of the compartment; and
a key-operated lock cylinder positioned in the interior of the compartment and coupled to the mechanical link.

15. The vehicle of claim 14 wherein the exterior side of the vehicle door includes a layer of cladding and wherein the access door is positioned in the cladding.

16. The vehicle of claim 9 wherein the mechanical link is a cable.
